(19) United States
(12) Patent Application Publication
(10) Pub. No.: US 2026/0351500 A1
(43) Pub. Date: Nov. 5, 2026

(54) TEMPERATURE-DEPENDENT SWITCH

(71) Applicant: Marcel P. Hofsaess, Steintahleben (DE)

(72) Inventor: Marcel P. Hofsaess, Steintahleben (DE)

(21) Appl. No.: 19/656,269

(22) Filed: Apr. 23, 2026

(30) Foreign Application Priority Data
Apr. 30, 2025 (DE) 10 2025 116 805.9

(51) Int. Cl. H01H 37/54; H01H 37/04

(52) U.S. Cl. CPC H01H 37/54; H01H 37/04

(57) ABSTRACT

A temperature-dependent switch having a temperature-dependent switching mechanism which is arranged in a switch housing and is configured to switch in a temperature-dependent manner between closed and open states. The temperature-dependent switch further comprises an inner switch casing which surrounds the switch housing, includes an insulating material, a first opening for a first connection lead, and a second opening for a second connection lead. The temperature-dependent switch has an outer switch casing which surrounds the inner switch casing and comprises a first casing component made of an electrically conductive material or an insulating material and a second casing component made of an insulating material, wherein the first and second casing components are joined by means of a filler material. The second casing component has a third opening for the first connection lead and a fourth opening for the second connection lead, both of which are sealed with the filler material.

### CROSS-REFERENCE TO RELATED APPLICATIONS

This application claims priority from German patent application DE 10 2025 116 805.9 filed on Apr. 30, 2025. The entire content of this priority application is incorporated herein by reference.

### FIELD

This disclosure relates to a temperature-dependent switch.

An exemplary temperature-dependent switch is disclosed in DE 37 33 693 A1.

Such temperature-dependent switches serve, in a manner known in the art, to monitor the temperature of a device. For this purpose, the switch is brought into direct or indirect thermal contact with the device to be protected, so that the temperature of the device to be protected influences the temperature of the switching mechanism arranged in the interior of the switch.

The switch is typically connected electrically in series into the power supply circuit of the device to be protected via connection leads, so that below the response temperature of the switch, the supply current of the device to be protected flows through the switch.

Such temperature-dependent switches include a temperature-dependent switching mechanism, which is encapsulated in a switch housing and which, depending on its temperature, opens or closes an electrically conductive connection between the two electrical terminals of the switch. More precisely, the temperature-dependent switching mechanism is configured to switch in a temperature-dependent manner between a closed state, in which the switching mechanism establishes the electrically conductive connection between the two electrical terminals of the switch, and an open state, in which the switching mechanism disconnects the electrically conductive connection. In the closed state, the switching mechanism usually presses a movable contact part against at least one static contact and thus establishes the electrical connection between the two terminals of the switch. In the open state, however, the switching mechanism holds the movable contact part at a distance from the at least one static contact, so that the electrical connection between the two terminals of the switch is interrupted.

The switching behavior, i.e. the switching between the closed state and the open state, occurs in a temperature-dependent manner. A bimetal element is typically responsible for the temperature-dependent switching behavior of the switching mechanism, which, in a known manner, snaps over or snaps back in a temperature-dependent manner according to a hysteresis between two configurations, a low-temperature configuration or a low-temperature state and a high-temperature configuration or a high-temperature state.

Thus, if the temperature of the bimetal element increases as a result of a temperature increase at the device to be protected above a defined temperature, which is referred to as the response temperature or switching temperature of the bimetal element, the bimetal element snaps from its low-temperature configuration to its high-temperature configuration and thus causes a switching operation from the closed state to the open state or vice versa. Depending on the installation type, the switch can be designed such that it is in the closed state below the response or switching temperature, which is referred to as “normally closed”, or instead is then in the open state, which is typically referred to as “normally open”.

For certain applications, such temperature-dependent switches must be equipped with special encapsulations, which are mostly to be provided in addition to the conventional switch housing of the switch. This is necessary, for example, when such temperature-dependent switches are used in corrosive or explosive environments. The same applies when temperature-dependent switches are used in environments in which the switches are exposed to comparatively high external pressures.

In the application cases described above, it may be prescribed for safety reasons that the temperature-dependent switches are configured to be hermetically gas-tight or are encapsulated in a hermetically gas-tight manner.

In the switch disclosed in the aforementioned DE 37 33 693 A1, this is solved by placing the switch in an additional metal housing, which is welded to the metal housing with a separate lid, which is also made of metal, after the switch has been inserted. This lid provides for pressure glass feedthroughs made of fused glass, through which the connection leads of the switch extend from the inside to the outside. Before the hermetically sealed closing of the metal housing, but after the insertion of the switch, the metal housing is flushed with an inert gas, preferably helium or nitrogen, and optionally filled with this gas. The connection leads are typically laser-welded and the pressure glass feedthroughs are fusion-bonded with the metal housing. In this way, a hermetically encapsulated temperature switch can be provided which can be used in corrosive and explosive environments.

Although the switch disclosed in DE 37 33 693 A1 has proven to be extremely advantageous in practice as a whole, some disadvantages have nevertheless become apparent over the years. Due to the introduction of the switch into a metal housing, it is fundamentally only possible to use temperature-dependent switches whose switch housing is not live, since otherwise an electrical short circuit would occur due to the direct contact of the switch housing with the metal housing which surrounds the switch housing, or at least the outer metal housing would also be live, which is to be avoided.

Furthermore, this switch has only a limited pressure resistance. In particular, in the region of the connection between the connection leads and the terminal surfaces of the switch housing, there is a risk of breakage, since the connection leads are insufficiently supported and for the most part extend freely through the interior of the metal housing, which is filled with gas. At the same time, this also makes the hermetic sealing of the metal housing more difficult.

Due to the fact that a large part of the interior of the metal housing is filled with gas or is evacuated, there is, moreover, an insufficient thermal coupling of the switch housing to the electrical device to be monitored. In addition, when closing the switch housing or when attaching the pressure glass feedthroughs made of fused glass, damage to the temperature-dependent switching mechanism arranged in the interior of the switch housing can occur. Such fused glass leads to extremely high temperatures during their production. Conventional temperature-dependent switching mechanisms that are used inside the switch can, however, typically be exposed to a maximum of 200-500 °C without damage occurring to the bimetal part used therein. It should therefore be strictly avoided that the fused glass comes too close to the switch housing in which the temperature-dependent switching mechanism is arranged.

Due to the necessary welding process between the casing and the lid, steel must necessarily be used as the material for the metal housing in the switch disclosed in DE 37 33 693 A1. Metals with a comparatively better thermal conductivity, such as brass, cannot be used here as they cannot be welded.

### SUMMARY

It is an object to provide a temperature-dependent switch which overcomes or at least largely eliminates the above-mentioned disadvantages. In this context, it is a particular object to provide a temperature-dependent switch which is constructed to be more pressure-resistant, has a basic structure which is suitable for both live switch housings and non-live switch housings and, moreover, is comparatively simple and reliable to manufacture.

According to an aspect, a temperature-dependent switch is presented, comprising: a switch housing; a first terminal; a second terminal; a temperature-dependent switching mechanism disposed in the switch housing and configured to switch in a temperature-dependent manner between a closed state, in which the switching mechanism establishes an electrically conductive connection between the first terminal and the second terminal, and an open state, in which the switching mechanism interrupts the electrically conductive connection; a first electrical lead connected to the first terminal; a second electrical lead connected to the second terminal; an inner casing surrounding the switch housing, the inner casing being at least partially formed of an insulating material and including a first opening through which the first electrical lead extends and a second opening through which the second electrical lead extends; and an outer casing surrounding the inner casing and comprising a first casing component formed of an electrically conductive material or an insulating material, and a second casing component formed of an insulating material, wherein the first casing component is joined to the second casing component via a filler material, and wherein the second casing component includes a third opening through which the first electrical lead extends and a fourth opening through which the second electrical lead extends, the third opening and the fourth opening being sealed by the filler material.

The switch thus comprises two switch casings, an inner switch casing which surrounds the switch housing in which the temperature-dependent switching mechanism is arranged, and an outer switch casing in which the inner switch casing is arranged and which surrounds the inner switch casing. The electrical connection leads of the switch are led out through respective openings from the inner switch casing and the outer switch casing. For better distinguishability, these openings are referred to herein as first, second, third and fourth openings.

Furthermore, the two openings provided in the outer switch casing, i.e. the third opening and the fourth opening, are each sealed with a filler material. The connection point between the connection leads and the openings in the outer switch casing is thus completely sealed. The filler material simultaneously serves for the material-bonded connection of the two casing components of the outer switch casing.

The outer switch casing is constructed in two parts. It comprises a first casing component made of electrically conductive material or insulating material and a second casing component made of insulating material. The openings (third opening and fourth opening), through which the connection leads are passed and which are sealed by means of the filler material, are provided in the second casing component, which is made of insulating material.

The two-part construction of the outer switch casing allows for a simple insertion of the inner switch casing, in which the switch housing is arranged. The sealing by the filler material ensures a stable, material-bonded connection of the two casing components of the outer switch casing and at the same time a sealing or sealing of the switch interior.

The use of two switch casings surrounding each other (inner switch casing and outer switch casing) ensures a comparatively high pressure resistance, so that the switch housing, which is encapsulated in the two switch casings, is thereby optimally protected against external pressure influences.

In addition, this “double” switch casing has the advantage that filler material, which is used in the manufacture of the switch, inter alia, for sealing the third and fourth openings in the outer switch casing, cannot get to the switch housing itself, since the inner switch casing is provided as an additional enclosure for the switch housing. This is particularly advantageous when the filler material is fused glass which, as mentioned, has very high temperatures in the molten state during manufacture.

In a refinement, the filler material comprises a glass layer of fused glass, which hermetically seals the outer switch casing.

“Hermetically sealed” or “hermetically gas-tight” is understood herein to preferably mean a hermetic connection that meets the requirements of DIN EN 600 79-15. According to this, a hermetically sealed or hermetically gas-tight connection or device is understood to be a connection/device which is constructed in such a way that it cannot be opened and which is so effectively sealed by fusion bonding that the ingress of the external atmosphere is prevented. Such a hermetic connection preferably enables a vacuum-tight connection between the first and the second casing component of the outer switch casing, which prevents a substance exchange from the inside to the outside and from the outside to the inside. Typically, such hermetic seals have a leak rate of <1· 10-7 mbar l/s determined by means of a helium leak detector. Achieving such a hermetically sealed device/connection according to DIN EN 600 79-15 is, as a general rule, achieved by fusion bonding of metal to metal or glass to metal or glass to ceramic.

In this refinement, the fused glass ensures a hermetically tight sealing of the third and fourth openings, through which the connection leads of the switch are passed through the outer switch casing, and at the same time ensures a hermetically gas-tight, material-bonded connection of the two casing components of the outer switch casing.

The glass layer preferably covers an outer top side of the second casing component, which faces away from the inner switch casing, completely and is connected along its outer circumference to the first casing component.

In a further refinement, the filler material comprises a second layer, arranged on the glass layer, made of an electrically insulating material, in particular of silicone or epoxy resin, through which the first and the second connection lead are each passed.

This second layer improves in particular the mechanical stabilization of the connection leads and thus prevents an undesirable breakage of the connection leads at the connection point thereof with the typically rather brittle glass layer.

Of course, the filler material may also comprise three layers, namely a layer of fused glass, a layer of silicone arranged thereon, and a layer of epoxy resin arranged over the silicone layer. In such an arrangement, the layer of fused glass, as mentioned, ensures a hermetically gas-tight sealing of the switch interior. The silicone layer serves as a comparatively soft, resilient connection layer to avoid hairline cracks. The epoxy resin layer lying thereabove serves for additional sealing and stabilization of the connection leads in order to prevent a breakage thereof. This is particularly advantageous in the case of stable connection lugs made of metal, which are configured as stable, uninsulated sheet metal parts. Such connection lugs are preferably joined to the switch housing in a materially bonded manner.

In a further refinement, the first casing component and the second casing component of the outer switch casing together form a cup-shaped recess into which the filler material is introduced. This facilitates the filling of the filler material many times over and at the same time prevents the filler material from flowing undefinedly over the surface of the outer switch casing and/or reaching undesirable places during manufacture.

Here, it is particularly preferred that the first casing component is cup-shaped and receives the inner switch casing, and that the second casing component is configured as a lid which closes the cup-shaped first casing component, wherein the cup-shaped recess is formed by a top side of the second casing component facing away from the inner switch casing and by a free, upper edge of the first casing component, which circumferentially surrounds the second casing component.

The filling of the filler material is thus particularly simple. At the same time, a very dense sealing of the outer switch casing is created. In addition, a space-saving arrangement is achieved.

In a further refinement, the second casing component of the outer switch casing rests on the inner switch casing.

The direct contact between the second casing component of the outer switch casing and the inner switch casing on the one hand improves the thermal coupling of the switch and on the other hand simplifies the manufacture of the switch, since the second casing component only has to be placed on the inner switch casing during manufacture, whereby a defined abutment is created. In addition, this ensures a pressure-resistant construction of the “double” switch casing.

In a further refinement, the inner switch casing comprises a cup-shaped third casing component, which receives the switch housing, and a fourth casing component, which is configured as a lid that closes the cup-shaped third casing component.

Thus, the inner switch casing is also preferably constructed in two parts. This simplifies in particular the insertion of the switch housing into the inner switch casing during the manufacture of the switch. The inner switch casing does not necessarily have to be completely sealed, since the sealing is, as mentioned, already provided by the outer switch casing. The fourth casing component can therefore also rest loosely on the third casing component. Likewise, the fourth casing component can be connected to the third casing component in a materially bonded, force-fitting and/or positive-locking manner.

Both the third casing component and the fourth casing component are preferably made of an insulating material, particularly preferably of ceramic. This makes it possible to also insert live switch housings into the inner switch casing. Ceramic is preferred as a material for the inner switch casing in that ceramic has a comparatively high thermal conductivity, which improves the thermal coupling of the switch to the device to be protected.

In a further refinement, the inner switch casing is inserted in a positive-locking manner into the outer switch casing.

This in turn also facilitates the assembly of the switch. In addition, it ensures that the inner switch casing is positionally fixed in the outer switch casing and thus does not move accidentally, which is particularly advantageous when the switch is exposed to vibrations during use. In addition, this refinement in turn improves the thermal coupling of the temperature-dependent switch when there is direct contact between the inner switch casing and the outer switch casing.

In a further refinement, the inner switch casing surrounds the switch housing on all sides and the outer switch casing surrounds the inner switch casing on all sides.

Two complete shells are thus formed around the switch housing. At the same time, the switch housing preferably completely surrounds the temperature-dependent switching mechanism. The temperature-dependent switching mechanism is thus maximally protected. The switch is constructed to be extremely pressure-resistant.

In a further refinement, an intermediate space between the inner switch casing and the outer switch casing is filled with a cured, second filler material.

This avoids air or gas inclusions between the inner switch casing and the outer switch casing. This in turn improves on the one hand the thermal coupling and on the other hand provides for a positional fixation of the inner switch casing in the outer switch casing, whereby a wobbling of the inner switch casing is avoided when it is subjected to vibrations or other shocks.

In an alternative refinement, a spring element is arranged between the inner switch casing and the outer switch casing, which is configured to resiliently clamp the inner switch casing in the outer switch casing.

This possibility also ensures a stable connection between the inner switch casing and the outer switch casing and thus a sufficiently good thermal coupling. At the same time, the resilient configuration also serves for the springing or damping that protects the switch from external shocks.

In a further refinement, the first connection lead is passed in each case in a positive-locking manner through the first opening and the third opening, and likewise the second connection lead is passed in each case in a positive-locking manner through the second opening and the fourth opening.

This has the particular advantage that it prevents the filler material, which is used in particular for sealing the third opening and the fourth opening, from getting into the interior of the outer switch casing or even into the interior of the inner switch casing. A positive-locking formation of the openings with the respective connection leads is also possible with uninsulated connection leads made of sheet metal, since the inner switch casing and the second casing component of the outer switch casing are each made of insulating material, whereby an electrical short circuit between the two connection leads is automatically prevented.

In a further refinement, the first opening is aligned with the third opening and the second opening is aligned with the fourth opening. The first opening and the second opening preferably run parallel to each other but offset. Accordingly, the third opening and the fourth opening also preferably run parallel to each other but offset.

When the first opening is aligned with the third opening or the second opening is aligned with the fourth opening, this has the advantage that the connection leads do not have to be bent in the switch interior. This is particularly advantageous in the case of stable connection lugs made of sheet metal.

In a further refinement, the first casing component is made of metal and the second casing component as well as the inner switch casing are made of ceramic.

This combination ensures on the one hand a maximum pressure resistance and on the other hand a best possible thermal coupling of the switch.

It is understood that the features mentioned above and those yet to be explained below can be used not only in the combination specified in each case, but also in other combinations or in isolation, without departing from the spirit and scope of the present disclosure.

### BRIEF DESCRIPTION OF THE DRAWINGS

FIG. 1 is a schematic sectional view of an exemplary temperature-dependent switch according to the prior art, wherein the switch is in its closed state;

FIG. 2 is a schematic sectional view of the switch shown in FIG. 1, wherein the switch is in its open state;

FIG. 3a is a schematic first cross-sectional view and FIG. 3b is a schematic second cross-sectional view of a first embodiment of a temperature-dependent switch;

FIG. 4a is a schematic first cross-sectional view and FIG. 4b is a schematic second cross-sectional view of a second embodiment of the temperature-dependent switch;

FIG. 5a is a schematic first cross-sectional view and FIG. 5b is a schematic second cross-sectional view of a third embodiment of the temperature-dependent switch; and

FIG. 6a is a schematic first sectional view and FIG. 6b is a schematic second cross-sectional view of a fourth embodiment of the temperature-dependent switch.

### DESCRIPTION OF PREFERRED EMBODIMENTS

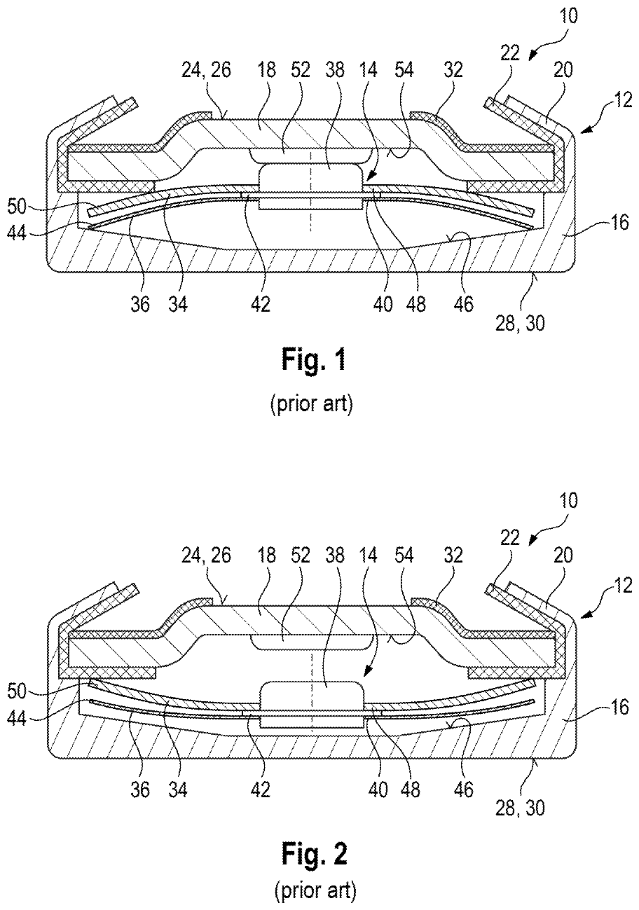

FIGS. 1 and 2 show an exemplary temperature-dependent switch, as known from the prior art, to illustrate the basic structure of such a temperature-dependent switch and its mode of operation. The switch is designated in its entirety by reference number 10.

FIG. 1 shows the closed position of the switch 10. FIG. 2 shows the open position of the switch 10.

It is understood that the switch 10 shown in FIGS. 1 and 2 is only one example of various possible temperature-dependent switches that are generally suitable for the configuration of a switch according to the present disclosure. However, switches with different structural designs may also be used according to the disclosure.

The switch 10 shown in FIGS. 1 and 2 comprises a switch housing 12, in the interior of which a temperature-dependent switching mechanism 14 is arranged. The switch housing 12 comprises a cup-shaped lower part 16 and a lid part 18, which is held on the lower part 16 by a bent or flanged upper edge 20 of the lower part 16.

In the example of switch 10 shown in FIGS. 1 and 2, both the lower part 16 and the lid part 18 are made of an electrically conductive material, preferably metal. An insulating film 22 is arranged between the lower part 16 and the lid part 18. The insulating foil 22 provides for an electrical insulation of the lower part 16 with respect to the lid part 18. Likewise, the insulating foil 22 provides for a mechanical sealing which prevents liquids or contaminants from entering the interior of the switch housing 12 from the outside.

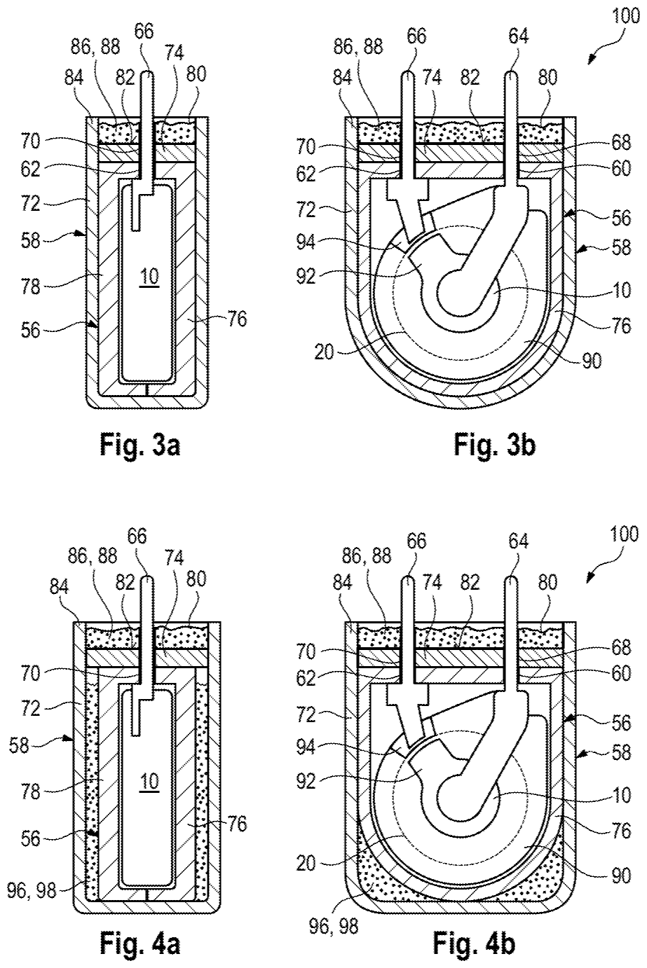

Since the lower part 16 and the lid part 18 in this example are each made of electrically conductive material, the outer surfaces of the lower part 16 and of the lid part 18 can serve for the electrical connection of the switch 10. Thus, for example, the outer surface 24 of the lid part 18 can function as the first electrical terminal 26 of the switch 10. The outer surface 28 of the lower part 16 can function as the second terminal 30 of the switch 10. As shown for example in FIGS. 3a-6b, connection leads can be attached to these two terminals 26, 30 of the switch 10.

On the outside of the lid part 18, in the example of the switch 10 shown in FIGS. 1 and 2, a further insulation layer 32 is also arranged.

The switching mechanism 14 is clamped between the lower part 16 and the lid part 18. The switching mechanism 14 comprises a bimetal element 34, a spring element 36 and a movable contact part 38. The bimetal element 34 comprises a temperature-dependent bimetal snap-action disc with a central opening provided therein, with which the bimetal snap-action disc is placed over the movable contact part 38.

The spring element 36 comprises a temperature-independent spring snap-action disc, which is also placed over the movable contact part 38 with a central opening provided therein, but from an opposite lower side. The two snap-action discs 34, 36 are thus placed over the movable contact part 38 from opposite sides.

In the closed state of the switch 10 shown in FIG. 1, the spring snap-action disc 36 carries the movable contact part 38 from below by pressing with its inner edge region 40 from below against a circumferential, annular collar 42 of the movable contact part 38. In this case, the spring snap-action disc 36 is supported with its outer, circumferential edge 44 on the inner bottom 46 of the lower part 16.

In this state of the switch 10, the bimetal snap-action disc 34 rests with its inner edge region 48 preferably freely on the collar 42 of the movable contact part 38 from the opposite upper side. The outer, circumferential edge 50 of the bimetal snap-action disc 34 hangs freely into the interior of the switch housing 12. The bimetal snap-action disc 34 is thus mounted in this type of switch 10 in the closed state almost force-free in the switch housing 12, without being firmly clamped therein.

In the low-temperature state of the switch 10 shown in FIG. 1, the temperature-dependent switching mechanism 14 establishes an electrically conductive connection between the two electrical terminals 26, 30 of the switch 10 by pressing the movable contact part against a stationary or static contact 52 arranged on the lid part 18. The contact pressure with which the movable contact part 38 is pressed against the static contact 52 in the closed state of the switch 10 is effected in the switch 10 by the spring snap-action disc 36.

If, starting from the closed state of the switch 10 shown in FIG. 1, the temperature of the device to be protected and thus the temperature of the switch 10 and of the bimetal snap-action disc 34 arranged therein increases to or above the response temperature of the bimetal snap-action disc 34, the bimetal snap-action disc 34 snaps from its convex low-temperature configuration shown in FIG. 1 into its concave high-temperature configuration shown in FIG. 2. During this snapping over, the bimetal snap-action disc 34 is supported with its outer edge 50 on the underside 54 of the lid part 18. With its center or its inner edge region 48, the bimetal snap-action disc 34 thereby presses the movable contact part 38 downwards and lifts the movable contact part 38 off the static contact 52. As a result, the spring snap-action disc 36 simultaneously bends downwards at its center, so that the spring snap-action disc 36 snaps from its first geometric configuration shown in FIG. 1 into its second geometric configuration shown in FIG. 2. The previously established electrically conductive connection between the two electrical terminals 26, 30 of the switch 10 is thereby interrupted.

The temperature-dependent switching mechanism 14 of the switch 10 is thus configured to establish and disconnect the electrically conductive connection between the two terminals 26, 30 in a temperature-dependent manner. In a configuration of the switch 10 which is referred to as “normally closed”, the switching mechanism 14 is below the response temperature of the bimetal snap-action disc 34 in the closed state shown in FIG. 1, in which it establishes the electrically conductive connection between the two outer terminals 26, 30. Above the response temperature of the bimetal snap-action disc 34, the switching mechanism 14 is in its open state shown in FIG. 2.

In principle, however, this can also be configured in reverse, so that the switching mechanism 14 is in the open state shown in FIG. 2 below the response temperature of the bimetal snap-action disc 34 and is in the closed state shown in FIG. 1 above the response temperature of the bimetal snap-action disc 34. This is then referred to as “normally open”.

FIGS. 3a and 3b show a first embodiment of the switch, which is denoted therein in its entirety by reference numeral 100. FIG. 3a shows a schematic first cross-sectional view of the switch 100 (longitudinal cross-section of the switch 100). FIG. 3b shows a schematic second cross-sectional view of the switch 100 (cross section perpendicular to the first cross section).

In addition to the components of the switch 10, as exemplified in FIGS. 1 and 2, the switch 100 comprises a multi-part switch casing in which the switch 10 is encapsulated.

In the following, the structure of this switch casing will explained. For the sake of simplicity, the components of the switch 10, as they are shown in FIGS. 1 and 2 and can also be components of the switch 100, are not shown in cross-section again in the sectional views of FIGS. 3a and 3b. Instead, FIGS. 3a and 3b show the switch 10, which forms the inner part of the switch 100, in an uncut form, so that only the switch casing, which surrounds the switch 10, is shown in section in each case.

The multi-part switch casing comprises an inner switch casing 56 and an outer switch casing 58. The inner switch casing 56 surrounds the switch housing 12 of the switch 10 and preferably surrounds it completely except for two openings 60, 62, through which the connection leads 64, 66 of the switch 100 are led out. The outer switch casing 58 surrounds the inner switch casing 56, preferably completely except for two openings 68, 70, through which the connection leads 64, 66 are led out. The openings 60, 62 provided in the inner switch casing 56 for leading out the connection leads 64, 66 are referred to herein as “first opening” 60 and “second opening” 62. The openings 68, 70 provided in the outer switch casing 58 for passing through the connection leads 64, 66 are referred to herein as “third opening” 68 and “fourth opening” 70.

The first opening 60 provided in the inner switch casing 56 is preferably aligned with the third opening 68 provided in the outer switch casing 58. Likewise, the first opening 62 provided in the inner switch casing 56 is preferably aligned with the fourth opening 70 provided in the outer switch casing 58, in order to simplify the leading out of the connection leads 64, 66 from the two switch casings 56, 58 and to avoid the connection leads 64, 66 having to be bent for this purpose.

Both switch casings, i.e. the inner switch casing 56 and the outer switch casing 58, are each constructed in two parts. The outer switch casing 58 has a first casing component 72 and a second casing component 74. The inner switch casing 56 has a third casing component 76 and a fourth casing component 78.

The first casing component 72 of the outer switch casing 58 can in principle be made of both an electrically conductive material and an insulating material. In the embodiment shown here, the first casing component 72 is made of metal. This has the particular advantage that the thermal coupling of the switch 100 is thereby improved. In addition, metal, for example steel, has a lower brittleness than, for example, ceramic, which could also be used as an insulating material.

The second casing component 74 of the outer switch casing 58 is at least partially, preferably completely, made of an insulating material, preferably ceramic. At least the radially inner part of the second casing component 74, in which the openings 68, 70 are provided, should be made of insulating material in order to prevent an electrical short circuit between the two connection leads 64, 66.

The two casing components 72, 74 of the outer switch casing 58 function as a kind of cup and lid for receiving and closing the inner switch casing 56. The first casing component 72 is preferably cup-shaped. This first casing component 72 serves to receive the inner switch casing 56. The second casing component 74 is configured as a matching lid which closes the cup-shaped first casing component 72. The outer diameter of this second casing component 74, which is configured as a lid, is preferably equal to or smaller than the inner diameter of the first casing component 72. The second casing component 74, which is configured as a lid, is thus not placed on the cup-shaped first casing component 72 from above, but is preferably inserted into it. This results in a kind of cup-shaped recess 80, which is defined by a top side 82 of the second casing component 74 and a free, upper edge 84 of the first casing component 72. The top side 82 of the second casing component 74 forms the bottom of this cup-shaped recess 80. The free, upper edge 84 of the first casing component 72 forms the circumferential side wall of this cup-shaped recess 80. The said top side 82 of the second casing component 74 is a side of the second casing component 74 which faces away from the inner switch casing 56.

The cup-shaped recess 80 is filled with a filler material 86. This filler material 86 preferably covers the top side 82 of the second casing component 74 completely and contacts the first casing component 72 circumferentially in the region of the free, upper edge 84. The filler material 86 serves on the one hand for the material-bonded connection between the first casing component 72 and the second casing component 74. On the other hand, the filler material 86 serves to seal the openings 68, 70, which are provided in the second casing component 74, through which the connection leads 64, 66 are passed. The connection leads 64, 66 are thus also passed through this filler material 86.

The filler material 86 comprises a glass layer 88 of fused glass. In other words, the outer switch casing 58 is sealed with the aid of this glass layer 88 of fused glass. A hermetically gas-tight sealing of the outer switch casing 58 thus preferably results. At the connection point between the glass layer 88 and the first casing component 72 of the outer switch casing 58, a metal-glass bond results which meets the requirements of a hermetically gas-tight device. At the connection point between the glass layer 88 and the top side 82 of the second casing component 74 of the outer switch casing 58, a glass-ceramic bond results which also meets the requirements of a hermetically gas-tight device. The connection between the glass layer 88 and the two outwardly led connection leads 64, 66 is also a glass-metal bond which is hermetically gas-tight. The connection leads 64, 66 are preferably in each case connection lugs made of uninsulated connection lugs of stable sheet metal.

The two casing components 76, 78 of the inner switch casing 56 are preferably also configured as a kind of cup and lid. The third casing component 76 is preferably cup-shaped and serves to receive the switch housing 12. The switch housing 12 is preferably received therein in a positive-locking manner in order to prevent the switch housing 12 from moving within the inner switch casing 56. The fourth casing component 78 closes the third casing component 76 as a kind of lid. For leading out the connection leads 64, 66, two recesses are provided in the third casing component 76, which form the openings 60, 62.

Both the third casing component 76 and the fourth casing component 78 are preferably made of insulating material, particularly preferably of ceramic. This ensures on the one hand a good thermal coupling and on the other hand enables the electrically insulating reception of the switch 10 in the inner switch casing 56. Thus, switch housings 12 which are configured to be live, such as the switch housing 12 of the switch 10 shown in FIGS. 1 and 2, can also be inserted into the inner switch casing 56.

It should be noted here that the switch 10, as shown in FIGS. 1 and 2, is additionally surrounded in the first embodiment by an insulating protective layer 90, which is preferably configured as a stable cap which is placed on the switch housing 12. This insulating protective layer or cap 90 serves in particular to prevent the first connection lead 64, which is configured as a connection lug of stable sheet metal, from coming into contact with the second terminal 30 of the switch 10 and thereby causing an electrical short circuit. The cap 90 therefore has two recesses 92, 94. The first recess 92 leaves the top side 24 of the lid part 18 free, which functions as the first terminal of the switch 100. The first connection lead 64 can thus be connected to this first terminal. The first connection lead 64 is preferably joined to the first terminal 26 in a materially bonded manner, for example soldered thereto. The second recess 94 leaves a part of the bent-over or flanged upper edge 20 of the switch housing 12 free, which functions as the second terminal 30 of the switch 100. The circumferential, flanged upper edge 20 of the switch housing 12 is indicated by a dashed line in FIG. 3b.

The switch 10 is inserted in a positive-locking manner into the inner switch casing 56 and this in turn is inserted in a positive-locking manner into the outer switch casing 58. The second casing component 74, which is configured as a lid part, preferably rests on the inner switch casing 56. In this way, a very pressure-resistant switch housing of the switch 100 is created overall, which is additionally hermetically sealed due to the sealing by the glass layer 88.

FIGS. 4a and 4b show a second embodiment of the switch 100. This second embodiment differs from the embodiment shown in FIGS. 3a and 3b in particular in that an intermediate space 96 is provided between the inner switch casing 56 and the outer switch casing 58, which is filled with a cured second filler material 98.

This second filler material 98 is preferably an epoxy resin-based filling compound. On the one hand, this second filler material 98 serves to fix the first switch casing 56 in the second switch casing 58. On the other hand, the heat transfer between the inner switch casing 56 and the outer switch casing 58 and thus the entire thermal coupling of the temperature-dependent switch 100 is improved, since air or gas inclusions in the intermediate space 96 between the inner switch casing 56 and the outer switch casing 58 are avoided.

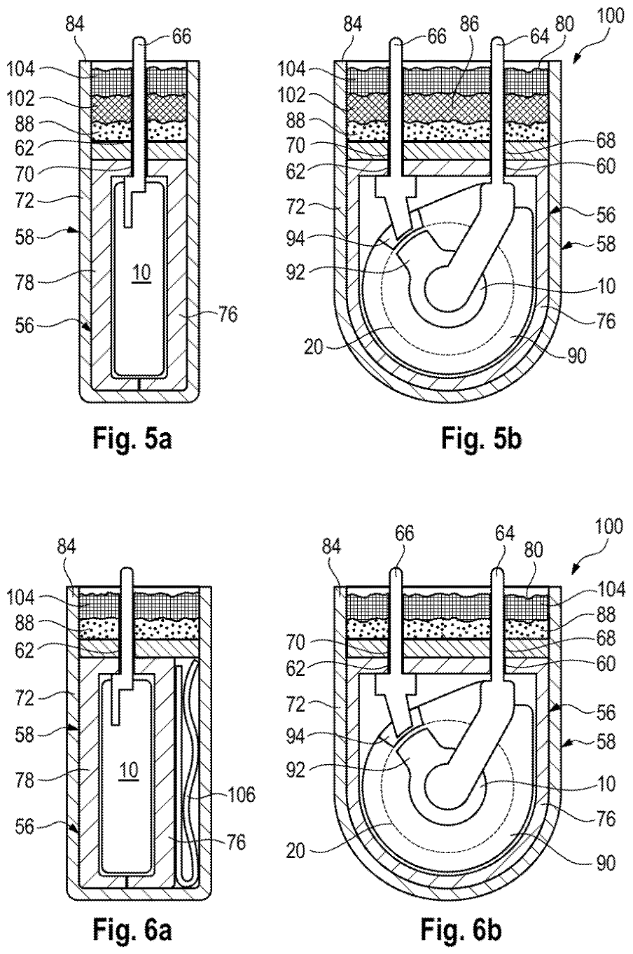

FIGS. 5a and 5b show a third embodiment of the switch 100. The inner switch casing 56 and the outer switch casing 58 are in this case constructed in the same way as according to the first embodiment shown in FIGS. 3a and 3b. However, the filler material 86 introduced into the cup-shaped recess 80 comprises, in addition to the glass layer 88, two further layers 102 and 104. The second layer 102, which is arranged on top of the glass layer 88, is preferably a layer of silicone. The third layer 104 lying thereabove is a layer of epoxy resin. The epoxy resin layer 104 contributes to the additional stabilization of the connection leads 64, 66. The silicone layer 102 lying therebetween serves as an intermediate layer between the glass layer 88 and the epoxy resin layer 104. This intermediate layer 102 provides in particular for a stress compensation of the typically very brittle glass layer 88 and thus prevents crack formation in one of the two layers 88, 104.

FIGS. 6a and 6b show a fourth embodiment of the switch 100. This differs from the third embodiment shown in FIGS. 5a and 5b in that a spring element 106 is provided here, which is arranged in the intermediate space 96 between the inner switch casing 56 and the outer switch casing 58. This spring element 106 serves to resiliently clamp the inner switch casing 56 in the outer switch casing 58. In addition, in comparison to the third embodiment shown in FIGS. 5a and 5b, the intermediate layer 102 of silicone is omitted here, so that the epoxy resin layer 104 is arranged directly on the glass layer 88.

It goes without saying that the features of the individual embodiments of the switch 100, as shown in FIGS. 3a-6b, can of course be combined with one another; however, a combination of the second filler material 98 (FIGS. 4a and 4b) provided according to the second embodiment with the spring element 106 (FIGS. 6a and 6b) provided according to the fourth embodiment could be technically less sensible.

Furthermore, it is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A temperature-dependent switch, comprising:
a switch housing;
a first terminal;
a second terminal;
a temperature-dependent switching mechanism disposed in the switch housing and configured to switch in a temperature-dependent manner between a closed state, in which the switching mechanism establishes an electrically conductive connection between the first terminal and the second terminal, and an open state, in which the switching mechanism interrupts the electrically conductive connection;
a first electrical lead connected to the first terminal;
a second electrical lead connected to the second terminal;
an inner casing surrounding the switch housing, the inner casing being at least partially formed of an insulating material and including a first opening through which the first electrical lead extends and a second opening through which the second electrical lead extends; and
an outer casing surrounding the inner casing and comprising a first casing component formed of an electrically conductive material or an insulating material, and a second casing component formed of an insulating material,
wherein the first casing component is joined to the second casing component via a filler material, and the second casing component includes a third opening through which the first electrical lead extends and a fourth opening through which the second electrical lead extends, the third opening and the fourth opening being sealed by the filler material.

2. The temperature-dependent switch of claim 1, wherein the filler material comprises a glass layer that forms a hermetic seal between the first casing component and the second casing component.

3. The temperature-dependent switch of claim 2, wherein the glass layer comprises fused glass.

4. The temperature-dependent switch of claim 2, wherein the glass layer covers an outer top surface of the second casing component facing away from the inner casing and is connected along an outer circumferential edge thereof to the first casing component.

5. The temperature-dependent switch of claim 2, wherein the filler material further comprises a second layer formed of an electrically insulating material disposed on the glass layer, the electrically insulating material comprising silicone, epoxy resin, or a combination thereof, the first electrical lead and the second electrical lead extending through the second layer.

6. The temperature-dependent switch of claim 1, wherein the first casing component and the second casing component together define a cup-shaped recess that contains the filler material.

7. The temperature-dependent switch of claim 6, wherein the first casing component is cup-shaped and configured to receive the inner casing, and the second casing component forms a lid that closes an opening of the first casing component, and wherein the cup-shaped recess is defined by a top surface of the second casing component facing away from the inner casing and by a free upper edge of the first casing component surrounding the second casing component.

8. The temperature-dependent switch of claim 1, wherein the second casing component is supported on the inner casing.

9. The temperature-dependent switch of claim 8, wherein the second casing component is in direct contact with the inner casing.

10. The temperature-dependent switch of claim 1, wherein the inner casing comprises a cup-shaped third casing component configured to receive the switch housing, and a fourth casing component forming a lid that closes the third casing component.

11. The temperature-dependent switch of claim 1, wherein the inner casing is received in the outer casing in a form-fitting manner.

12. The temperature-dependent switch of claim 1, wherein the inner casing encapsulates the switch housing, and the outer casing encapsulates the inner casing.

13. The temperature-dependent switch of claim 1, wherein an intermediate space between the inner casing and the outer casing contains a second filler material disposed.

14. The temperature-dependent switch of claim 13, wherein the second filler material comprises an epoxy resin.

15. The temperature-dependent switch of claim 1, wherein a spring element is disposed between the inner casing and the outer casing and is configured to resiliently retain the inner casing within the outer casing.

16. The temperature-dependent switch of claim 1, wherein the first electrical lead extends through the first opening and the third opening in a form-fitting manner, and the second electrical lead extends through the second opening and the fourth opening in a form-fitting manner.

17. The temperature-dependent switch of claim 1, wherein the first opening and the third opening are axially aligned, and the second opening and the fourth opening are axially aligned.

18. The temperature-dependent switch of claim 1, wherein the first casing component comprises a metal material, and the second casing component and the inner casing each comprise a ceramic material.

19. The temperature-dependent switch of claim 1, wherein the first electrical lead and the second electrical lead each comprise a connection lug formed of sheet metal.
